(19) United States
(12) Patent Application Publication
(10) Pub. No.: US 2020/0118249 A1
(43) Pub. Date: Apr. 16, 2020

(54) DEVICE CONFIGURED TO PERFORM NEURAL NETWORK OPERATION AND METHOD OF OPERATING SAME

(71) Applicant: SAMSUNG ELECTRONICS CO., LTD., SUWON-SI (KR)

(72) Inventor: TAE-UI KIM, SUWON-SI (KR)

(21) Appl. No.: 16/596,660

(22) Filed: Oct. 8, 2019

(30) Foreign Application Priority Data
Oct. 10, 2018 (KR) 10-2018-0120611

(51) Int. Cl. G06T 5/00; G06N 3/04; G06N 3/08; G06N 3/063; G06T 5/20; G06T 5/50

(52) U.S. Cl. CPC G06T 5/002; G06N 3/04; G06N 3/08; G06T 2207/20081; G06T 5/20; G06T 5/50; G06T 2207/20084; G06N 3/063

(57) ABSTRACT

A computing device configured to perform an operation of a neural network including a plurality of layers includes a memory in which a gain corresponding to each of the plurality of layers is stored, and a processor configured to receive an input image to generate a plurality of raw feature maps at each of the plurality of layers, apply a gain corresponding to each of the plurality of raw feature maps to generate a plurality of output feature maps, and generate an output image as a result of summation of the plurality of output feature maps due to an image reconstruction layer.

### CROSS-REFERENCE TO RELATED APPLICATION

This application claims the benefit of Korean Patent Application No. 10-2018-0120611, filed on Oct. 10, 2018, in the Korean Intellectual Property Office, the disclosure of which is incorporated herein in its entirety by reference.

### BACKGROUND

The inventive concept relates to methods and electronic systems including a neural network device capable of removing noise from an input image and generating an output image.

A neural network device is a computational system, structure or architecture that models a biological learning activities. With the recent developments in neural network devices and technology, research has actively been conducted into various kinds of electronic systems configured to analyze input data and provide corresponding, valid output data derived from processes performed by the neural network device.

### SUMMARY

The inventive concept provides a device configured to perform a neural network operation of removing noise from an input image and generating an output image using respective characteristics of a plurality of layers included in a neural network, and a method of operating the device.

According to an aspect of the inventive concept, there is provided a computing device configured to perform an operation of a neural network including a plurality of layers. The computing device includes a memory in which a gain corresponding to each of the plurality of layers is stored, and a processor configured to receive an input image to generate a plurality of raw feature maps at each of the plurality of layers, apply a gain corresponding to each of the plurality of raw feature maps to generate a plurality of output feature maps, and generate an output image as a result of summation of the plurality of output feature maps due to an image reconstruction layer.

According to another aspect of the inventive concept, there is provided a non-transitory computer-readable recording medium having recorded a program for generating an output image using a neural network device. The program includes operations of receiving an input image, generating a plurality of raw feature maps from some or all of cascade-connected convolution layers based on the input image, applying a gain corresponding to each of the plurality of generated raw feature maps and generating a plurality of output feature maps, and generating the output image based on the plurality of output feature maps. The gain is learned by a learning algorithm and updated when the operations are performed.

According to another aspect of the inventive concept, there is provided a computing device configured to perform an operation using a neural network including a plurality of layers. The computing device includes a sensor module configured to generate an input image including a first object, a memory in which a gain corresponding to each of the plurality of layers is stored, and a processor configured to receive the input image to generate a plurality of raw feature maps at each of the plurality of layers, apply a gain corresponding to each of the plurality of raw feature maps to generate a plurality of output feature maps, and generate an output image as a result of summation of the plurality of output feature maps due to an image reconstruction layer.

Due to the device configured to perform the neural network operation and the method of operating the device according to example embodiments, high-resolution images may be obtained by removing noise caused by various objects present between an image sensor and a subject.

### BRIEF DESCRIPTION OF THE DRAWINGS

Embodiments of the inventive concept will be more clearly understood from the following detailed description taken in conjunction with the accompanying drawings in which:

FIG. 1 is a block diagram of an electronic system according to an embodiment;

FIG. 2 is a diagram of an example of a neural network structure;

FIG. 3 is a block diagram of a neural network device according to an embodiment;

FIG. 4 is a diagram of a gain unit according to an embodiment;

FIG. 5A is a diagram of a neural network device using a gain multiplier according to an embodiment;

FIG. 5B is a diagram of a neural network device using a gain kernel according to an embodiment;

FIG. 6 is a block diagram of a neural network device according to an embodiment;

FIG. 7 is a block diagram of an operation of learning a neural network device according to an embodiment;

FIGS. 8A, 8B, and 8C are diagrams for explaining an input image and an output image obtained by removing noise in the input image; and

FIG. 9 is a flowchart of a method of operating an electronic system according to an embodiment.

### DETAILED DESCRIPTION OF EMBODIMENTS

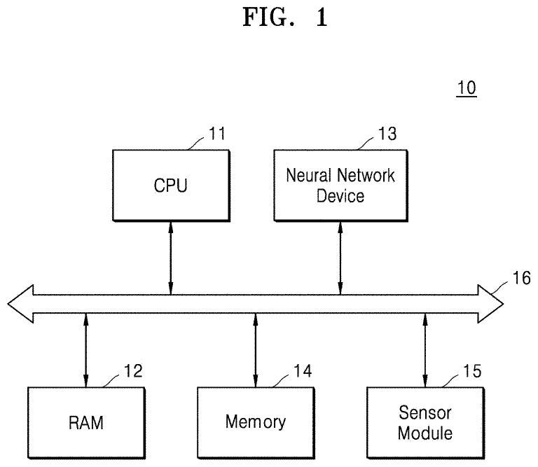

FIG. 1 is a block diagram illustrating an electronic system 10 according to an embodiment.

The electronic system 10 may be used to analyze input data in real-time using a neural network device 13, extract valid information from the analyzed input data, and control various components internal to and external from the electronic system 10 based on the extracted information. The electronic system 10 may be applied to a host device, such as a smartphone, a mobile device, an image display device, a measuring device, a smart TV, a drone, a robot, an advanced drivers assistance system (ADAS), a medical device, and an Internet of Things (IoT) device, etc. In this regard, the electronic system 10 may be operatively mounted in a host device, or integrated—wholly or in part—within a host device.

In certain embodiments the electronic system 10 of FIG. 1 may be implemented as an application processor (AP) within a host device. Since the electronic system 10 performs a neural network operation, possibly among many other operations, the electronic system 10 may be said to include a neural network system.

Referring to FIG. 1, the electronic system 10 may include a central processing unit (CPU) 11, random access memory (RAM) 12, the neural network device 13, a memory 14, and a sensor module 15. As will be understood by those skilled in the art, the electronic system 10 may further include one or more additional components, such as an input/output (I/O) module, a security module, and a power control module—although such modules are not shown in FIG. 1 for the sake of clarity.

Some or all of the constituent components (e.g., CPU 11, RAM 12, neural network device 13, memory 14, and/or sensor module 15) of the electronic system 10 may be implemented in a single semiconductor chip. For example, the electronic system 10 may be implemented as a System-on-Chip (SoC).

As illustrated in FIG. 1, the various components making up the electronic system 10 may communicate with using one or more signal lines and/or bus(es) having a variety of configurations, but generically indicated in FIG. 1 as bus 16.

The CPU 11 may be used to control the overall operation of the electronic system 10. In this regard, the CPU 11 may include one or more processing cores having a variety of architectures. The CPU 11 may process or execute programs and/or data stored in the memory 14. For example, the CPU 11 may execute the programs stored in the memory 14 in order to control various functions performed by the neural network device 13.

The RAM 12 may be used to temporarily store programs, data, and/or instructions. For example, programs and/or data stored in the memory 14 may be temporarily stored in the RAM 12 under the control of the CPU 11, or in response to execution of boot code by the CPU 11 (e.g.,) during a power-up operation. The RAM 12 may be variously implemented using, e.g., dynamic RAM (DRAM) and/or static RAM (SRAM).

The neural network device 13 may be used to perform various neural network operation(s) in relation to received input data to generate output data. Stated in other terms, input data received by the electronic system 10 may be analyzed (or processed) using the neural network device 13 in order to generate what will hereafter be referred to as “neural network operation results”.

In one particular application, a host device may include an image capture component, such as a camera, and image data obtained by use of the camera may be processed as input data. Generally speaking, input data (such as image data captured by a camera) often includes undesired noise components that should be removed, if possible, during the generation of corresponding output data. In certain embodiments, a neural network device may be used to remove noise from input data.

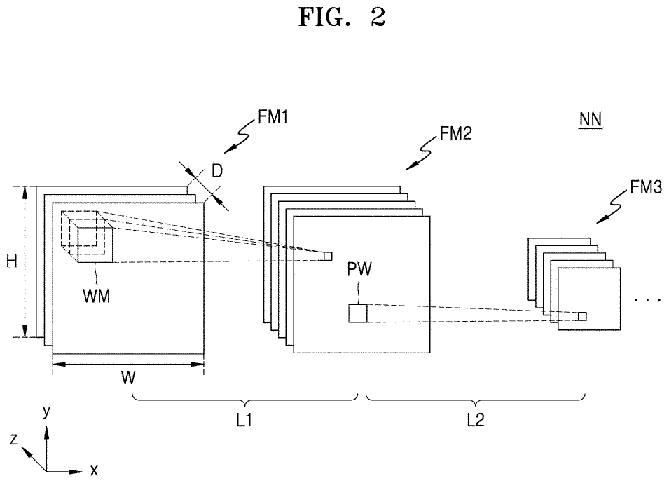

In this regard, the neural network device 13 of FIG. 1 may be variously implemented (or variously structured) as a computing device or a computing module. Those skilled in the art will understand that there are many types of neural networks or neural network devices, such as a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, and a classification network, etc. Further, a neural network configured to perform one or more task(s) may include one or more sub-neural network(s). One example of neural network structure will be described in some additional detail with reference to FIG. 2.

Referring to FIG. 2, a neural network NN may include first to n-th layers L1 to Ln, where each of the first to n-th layers L1 to Ln may be a linear layer or a nonlinear layer. In some embodiments, at least one linear layer and at least one nonlinear layer may be combined in a particular layer. For example, a linear layer may include a convolution layer and a fully connected layer, while a nonlinear layer may include a pooling layer and an activation layer.

As one example, a first layer L1 of FIG. 2 is assumed to be a convolution layer, a second layer L2 is assumed to be a pooling layer, and an n-th layer Ln is assumed to be a fully connected layer, or output layer. The neural network NN may further include an activation layer, as well as further layer(s) configured to perform other types of operations.

Each of the first to n-th layers L1 to Ln may (1) receive an input image frame or a feature map generated by a previous layer as an input feature map; (2) perform an operation on the input feature map; and (3) generate an output feature map. Here, the term “feature map” refers to data in which various characteristics of received input data are expressed. For example in FIG. 2, feature maps FM1, FM2, and FMn may have two-dimensional (2D) matrix forms or three-dimensional (3D) matrix forms. Feature maps FM1 to FMn, inclusive, may have a width W (hereafter referred to as a column), a height H (hereafter referred to as a row), and a depth D, which may respectively correspond to defined coordinates of an x-axis, a y-axis, and a z-axis. In the illustrated example of FIG. 2, the depth D refers to a channel number.

The first layer L1 may convolute a first feature map FM1 using a weight map WM to generate a second feature map FM2. The weight map WM may effectively filter the first feature map FM1 and may be referred to as a “filter” or a “kernel”. The depth (i.e., the channel number) of the weight map WM may be associated with (e.g., may be equal to) a depth (i.e., channel number) of the first feature map FM1, and channels of the weight map WM may be respectively convoluted with channels of the corresponding first feature map FM1. The weight map WM may be traversed (or “shifted”) using the first feature map FM1 as a sliding window. A shift amount may be referred to as a “stride length” or a “stride.” During each shift, each of the weights included in the weight map WM may be multiplied by and added to all feature values in a region that overlaps with the first feature map FM1. When the first feature map FM1 is convoluted using the weight map WM, one channel of the second feature map FM2 may be generated. Although only a single weight map WM is illustrated in FIG. 2, those skilled in the art will recognize that a plurality of weight maps may be substantially convoluted using the first feature map FM1 in order to generate a plurality of channels of the second feature map FM2. In other words, the number of channels of the second feature map FM2 may correspond to a number of weight maps.

The second layer L2 may be used to change a spatial size of the second feature map FM2 according to a pooling operation in order to generate a third feature map FM3. The pooling operation may take the form of a sampling operation or a down-sampling operation in certain embodiments. A 2D pooling window PW may be shifted on the second feature map FM2 in size units of the pooling window PW, and a maximum value (or average value) of features values of a region that overlaps with the pooling window PW may be selected. Thus, a third feature map FM3 having a desired spatial size may be generated from the second feature map FM2. The number of channels of the third feature map FM3 may be equal to the number of channels of the second feature map FM2.

In some embodiments, the second layer L2 need not be a pooling layer. That is, the second layer L2 may be a pooling layer or a convolution layer similar to the first layer L1. The second layer L2 may convolute the second feature map FM2 using a (second) weight map and generate the third feature map FM3. In this case, the (second) weight map used during the convolution operation performed by the second layer L2 may be different from the (first) weight map WM used during the convolution operation performed by the first layer L1.

An N-th feature map may be generated at an N-th layer through a plurality of layers including the first layer L1 and the second layer L2. The N-th feature map may be input to a reconstruction layer disposed on a back end of the neural network NN. Thus, the reconstruction layer may be used to generate output data. In certain embodiments, the reconstruction layer may convolute the N-th feature map using a weight map to generate output data (e.g., an output image in the particular example of an input image received from a camera). Hence, the reconstruction layer may or may not include a convolution layer, and in some embodiments, the reconstruction layer may be implemented as another kind of layer capable of appropriately reconstructing desired output data from the feature map.

Referring back to FIG. 1, “input data” received by the neural network device 13 may be a data associated with a still image or moving images (e.g., continuously received image frames) of the type routinely captured by a camera. The neural network device 13 may generate a feature map including a feature value of the input data, and thereafter reconstruct corresponding “output data” from the feature map.

In such embodiments, the neural network device 13 may store the feature map in an internal memory or an external memory (e.g., the memory 14), load the stored feature map, and convolute the loaded feature map using a weight map.

The memory 14 may include data storage media capable of storing and retrieving various data, program(s)—including at least one operating system (OS), data values, information, etc. In some embodiments, the memory 14 may be used to store a feature map generated during a neural network operation performed by the neural network device 13, as well as weight map(s) and associated information (e.g., gain) required by the neural network operation.

Hereinafter, the term “gain” collectively refers to values and/or data given to a raw feature map generated by a convolution layer. In some embodiments, gain may include a gain value obtained by multiplying the raw feature map by a gain multiplier or a gain kernel value included in a gain kernel.

The memory 14 may be variously implemented using one or more of DRAM and/or SRAM. Alternately or additionally, the memory 14 may include at least one non-volatile memory, such as read-only memory (ROM), programmable ROM (PROM), electrically programmable ROM (EPROM), electrically erasable and programmable ROM (EEPROM), flash memory, phase-change RAM (PRAM), magnetic RAM (MRAM), resistive RAM (RRAM), and/or ferroelectric RAM (FRAM). In some embodiments, the memory 14 may include at least one of hard disk drive (HDD), solid-state drive (SSD), compact flash (CF), secure digital (SD), micro secure digital (micro-SD), mini-SD, extreme digital (xD), or a memory stick.

The sensor module 15 may be used to collect information associated with the distance or proximity of the electronic system 10 (or a host device incorporating the electronic system 10) with an object being imaged. In this regard, the sensor module 15 may be used to sense or receive an externally generated image signal, and convert the sensed or received image signal into image data (e.g., image frame data). To this end, the sensor module 15 may include one or more sensing device(s) such as an optical and/or electrical imaging device, an optical and/or electrical image sensor, a light detection and ranging (LIDAR) sensor, an ultrasonic sensor, an infrared (IR) sensor, etc.

In certain embodiments, the sensor module 15 may provide the input data (e.g., image frame data) to the neural network device 13. For example, the sensor module 15 may be used to capture images selected from a surrounding environment of the electronic system 10 and provide corresponding input data to the neural network device 13.

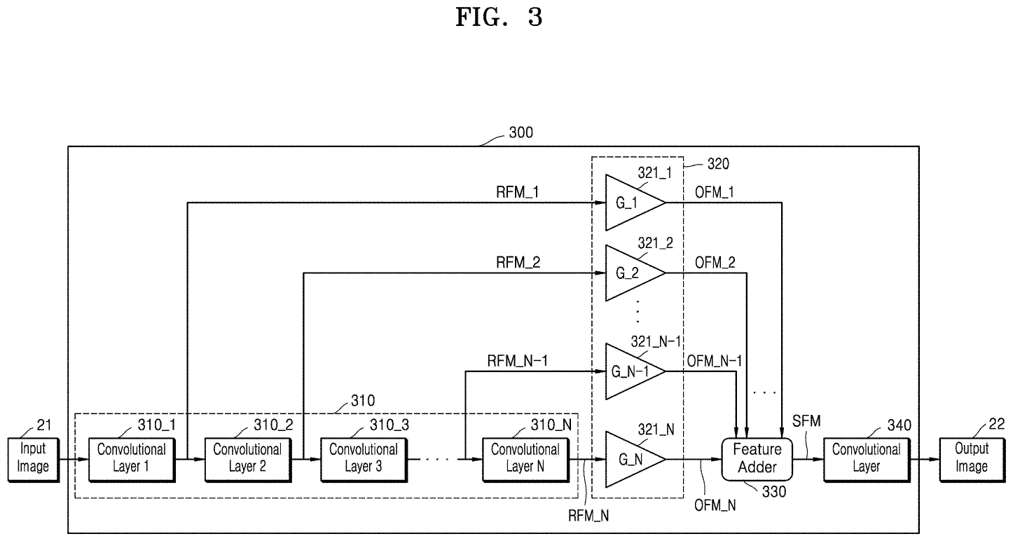

FIG. 3 is a block diagram further illustrating in one example (300) the neural network device 13 of FIG. 1.

The neural network device 300 may include a layer unit 310, a gain unit 320, a feature adder 330, and a reconstruction layer 340. The layer unit 310 may include first to N-th layers 310_1 to 310_N. The gain unit 320 may include first to N-th gain multipliers 321_1 to 321_N. At least some of the first to N-th layers 310_1 to 310_N may be implemented as convolution layers or pooling layers. The reconstruction layer 340 may be implemented as a convolution layer. Hereinafter, a case in which the first to N-th layers 310_1 to 310_N are convolution layers will be described. However, various other layers, such as a pooling layer, may be provided between or in place of the various convolution layers.

In relation to the illustrated example of FIG. 3, input data is received as an input image 21. The input image 21 may be image data loaded to the neural network device 300 from a memory (e.g., memory 14 of FIG. 1) or a sensor (e.g., sensor module 15 of FIG. 1). The input image 21 is assumed to include noise of the type commonly associated with optical imaging. This type of image noise may be caused by various unintended or interfering objects that may exist between the object being imaged and the imaging sensor. Alternately or additionally, interfering objects may include fog, dust, smoke, stains on a surface of the image sensor. Whatever their specific form, interfering objects cause image noise and image noise degrades the resolution of the input image 21. Image noise may be specifically associated with a portion of the object being imaged (e.g., glare or reflective), or it may be a general condition of the environment (e.g., the weather) surrounding the object.

The neural network device 300 may be implemented to perform various operations associated with the receipt of the input image 21, the removal of unwanted image noise from the input image 21, and the generation of a corresponding output image 22.

The neural network device 300 may generate feature maps including feature values of the input image 21 using the layer unit 310. According to one embodiment, the neural network device 300 may convolute the input image 21 with a first weight map at a first layer 310_1 and generate a first raw feature map RFM_1. The neural network device 300 may input the generated first raw feature map RFM_1 to a second layer 310_2. Subsequently, the neural network device 300 may convolute an i-th raw feature map with an i+1-th weight map at an i+1-th layer and provide an i+1-th raw feature map to an i+2-th layer. As used hereinafter, the value ‘i’ is a positive integer (i.e., i=1, 2, 3, . . . ). For example, the neural network device 300 may convolute the first raw feature map RFM_1 with a second weight map at the second layer 310_2 and provide a second raw feature map RFM_2 to a third layer 310_3.

According to another embodiment, the neural network device 300 may provide the first raw feature map RFM_1 generated at the first layer 310_1 to the second layer 310_2, and provide a first output feature map OFM_1—which is based on the first raw feature map RFM_1—to the feature adder 330.

Here, the neural network device 300 may process one or more characteristics of the input image 21 using the first to N-th layers 310_1 to 310_N included in the layer unit 310. As an example, the neural network device 300 may process various frequency data included in the input image 21 at the first to N-th layers 310_1 to 310_N. The neural network device 300 may process data having a high frequency range at the first layer 310_1 and increase resolution of at least one region of the input image 21. Alternately or additionally, the neural network device 300 may process data having a low frequency range at the second layer 310_2 and soften at least one region of the input image 21.

Alternatively, the neural network device 300 may adjust various image parameter values, such as Chroma, color temperature, contrast, luminance, and a gamma value, at each layer. For example, the neural network device 300 may process data related to different image parameters at each layer and process data related to the same image parameter (e.g., color temperature) at different levels at each layer. That is, the neural network device 300 may process contrast of an image at the first layer 310_1 and process Chroma of the image at the second layer 310_2. The neural network device 300 may also process data having a higher color temperature at the first layer 310_1 than at the second layer 310_2.

The neural network device 300 may apply a first gain value G_1 to the first raw feature map RFM_1 and generate the first output feature map OFM_1. For example, the first gain multiplier 321_1 may receive the first raw feature map RFM_1, multiply the first raw feature map RFM_1 by the first gain value G_1, and output the first output feature map OFM_1.

That is, the neural network device 300 may perform an operation on an i-th raw feature map by a gain corresponding to the i-th raw feature map and generate an i-th output feature map. In this case, an i+1-th raw feature map may be a feature map obtained by convoluting the i-th raw feature map with an i-th weight map. By applying a corresponding gain to a specific raw feature map RFM, characteristics of each layer at which the raw feature map RFM is generated may be reflected. That is, a gain applied to each raw feature map RFM may be different according to the raw feature map RFM, characteristics of some layers may be emphasized using gains, while characteristics of some other layers may be attenuated using some other gains. For instance, to emphasize characteristics of the first layer 310_1 more than those of the second layer 310_2, the first gain value G_1, which is multiplied by the first raw feature map RFM_1, may be greater than a second gain value G_2. Gains may be multiplied by a plurality of feature values included in the raw feature maps RFM to generate output feature maps OFM. For example, a gain value may be a real number value. Since at least some of first to N-th gain values G_1 to G_N have different real number values, characteristics of first to N-th raw feature maps RFM_1 to RFM_N may be differently emphasized.

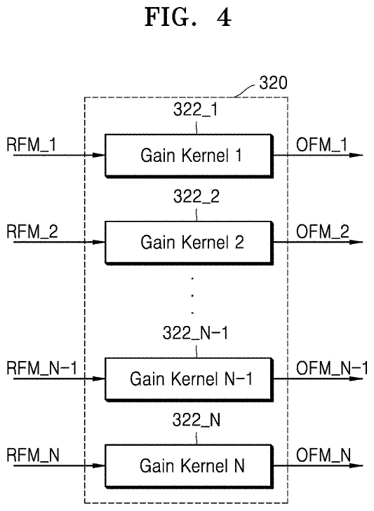

Another example of the gain unit 320 will be described in some additional detail with reference to FIG. 4. Unlike the embodiment illustrated in FIG. 3, the gain unit 320 may include first to N-th gain kernels 322_1 to 322_N. Hence, the neural network device 300 may perform an operation on an i-th raw feature map and an i-th gain kernel and generate an i-th output feature map.

According to an embodiment, the neural network device 300 may convolute a first raw feature map RFM_1 and the first gain kernel 322_1 and generate a first output feature map OFM_1. The first to N-th gain kernels 322_1 to 322_N may be implemented as a matrix form.

In this case, the i-th gain kernel may correspond to a matrix size of the i-th raw feature map. For example, the first gain kernel 322_1 may be implemented as a matrix corresponding to a size of the first raw feature map RFM_1. As another example, the first gain kernel 322_1 may be implemented as a matrix having a smaller size than the first raw feature map RFM_1. The neural network device 300 may convolute a plurality of feature values included in the first raw feature map RFM_1 with the first gain kernel 322_1 and generate the first output feature map OFM_1. In other words, the neural network device 300 may convolute a feature value included in the first raw feature map RFM_1 with a gain kernel value included in the first gain kernel 322_1 and generate a feature value included in the first output feature map OFM_1.

In certain embodiment, a “gain” will be a value that is learnable by the neural network device 300. Specifically, the first to N-th gain values G_1 to G_N described above with reference to FIG. 3 may be learnable values. Also, gain kernel values included in the first to N-th gain kernels 322_1 to 322_N shown in FIG. 4 may be learnable values. Thus, the gain kernels 322_1 to 322_N may be learnable matrices.

For example, during a learning process performed by the neural network device 300, the neural network device 300 may continuously learn the first to N-th gain values G_1 to G_N and the first to N-th gain kernels 322_1 to 322_N in order to remove noise from the input image 21. The first to N-th gain values G_1 to G_N and the first to N-th gain kernels 322_1 to 322_N may be learned as optimum values for removing noise from the input image 21. To implement the neural network device 300, the first to N-th gain values G_1 to G_N or the first to N-th gain kernels 322_1 to 322_N may be learned using the plurality of received pairs of input images 21 and output images 22. In this case, the plurality of pairs of input images 21 and output images 22 may be provided by a user or received via a web service or be paired with previously stored images.

Meanwhile, the gain unit 320 described above with reference to FIGS. 3 and 4 may be implemented as learnable values or preset values. For example, the first to N-th gain values G_1 to G_N or the first to N-th gain kernels 322_1 to 322_N included in the gain unit 320 may be implemented as preset values.

Referring back to FIG. 3, the neural network device 300 may generate the first to N-th raw feature maps RFM_1 to RFM_N from some or all of the first to N-th layers 310_1 to 310_N that may be cascade-connected.

As an example, the neural network device 300 may generate raw feature maps only from some of the first to N-th layers 310_1 to 310_N that may be cascade-connected. Only some of the layers may be used for computation to reduce the computational load placed on the neural network device 300. In this case, the neural network device 300 may generate output feature maps corresponding to raw feature maps generated at some layers. That is, the neural network device 300 may generate only output feature maps corresponding to raw feature maps out of first to N-th output feature maps OFM_1 to OFM_N.

As another example, the neural network device 300 may generate raw feature maps from all of the first to N-th layers 310_1 to 310_N that may be cascade-connected. Thus, the neural network device 300 may apply first to N-th raw feature maps RFM_1 to RFM_N to the gain unit 320 and generate first to N-th output feature maps OFM_1 to OFM_N.

As another example, the neural network device 300 may generate only some output feature maps. The neural network device 13 may generate raw feature maps from all of the first to N-th layers 310_1 to 310_N that may be cascade-connected. In this case, the neural network device 300 may generate the output feature maps using only some gain multipliers or some gain kernels included in the gain unit 320. The neural network device 300 may control the gain unit 320 to adjust some gain values to 0 or adjust some gain kernels to 0. For example, the neural network device 300 may adjust feature values of the first to N-th−1 output feature maps OFM_1 to OFM_N−1, except for the N-th output feature map OFM_N generated based on the N-th layer 310_N, to 0.

The neural network device 300 may be used to sum the first to N-th output feature maps OFM_1 to OFM_N using the feature adder 330. As an example, when the first to N-th output feature maps OFM_1 to OFM_N have the same size, the neural network device 300 may sum the output feature maps OFM_1 to OFM_N using the feature adder 330. As another example, the output feature maps OFM_1 to OFM_N may have different matrix sizes. In this case, the neural network device 300 may sum average values of the output feature maps OFM_1 to OFM_N having different sizes. Alternatively, the neural device 300 may perform a downsizing operation to adjust matrix sizes of the output feature maps OFM_1 to OFM_N to an output feature map having a smallest matrix size. Alternately, the neural network 300 may perform an upsizing operation to adjust the matrix sizes of the output feature maps OFM_1 to OFM_N to an output feature map having a largest matrix size.

In addition, the neural network device 300 may sum the output feature maps OFM_1 to OFM_N using various methods, for example, a method of adding feature values corresponding to the same row, column, and depth of the respective output feature maps OFM_1 to OFM_N and ignoring portions having different matrix sizes in a summation process. That is, the neural network device 300 may sum the output feature maps OFM_1 to OFM_N using various methods for reflecting feature values of the output feature maps OFM_1 to OFM_N.

The neural network device 300 may provide a summed feature map SFM, which is generated by the feature adder 330, to the reconstruction layer 340. The reconstruction layer 340 may reconstruct the summed feature map SFM into the output image 22. That is, the reconstruction layer 340 may be various kinds of layers configured to reconstruct a feature map into an image data type again. For example, the reconstruction layer 340 may be implemented as a convolution layer.

The neural network device 300 may apply a gain to each of the results output by the first to N-th layers 310_1 to 310_N included in the layer unit 310 using the gain unit 320 and control feature values output by the respective layers 310_1 to 310_N. The gain may be learned as an optimum gain to minimize noise of the input image 21. Thus, the neural network device 300 may be effectively used to remove noise from the input image 21 based on all of the characteristics associated with the layers 310_1 to 310_N.

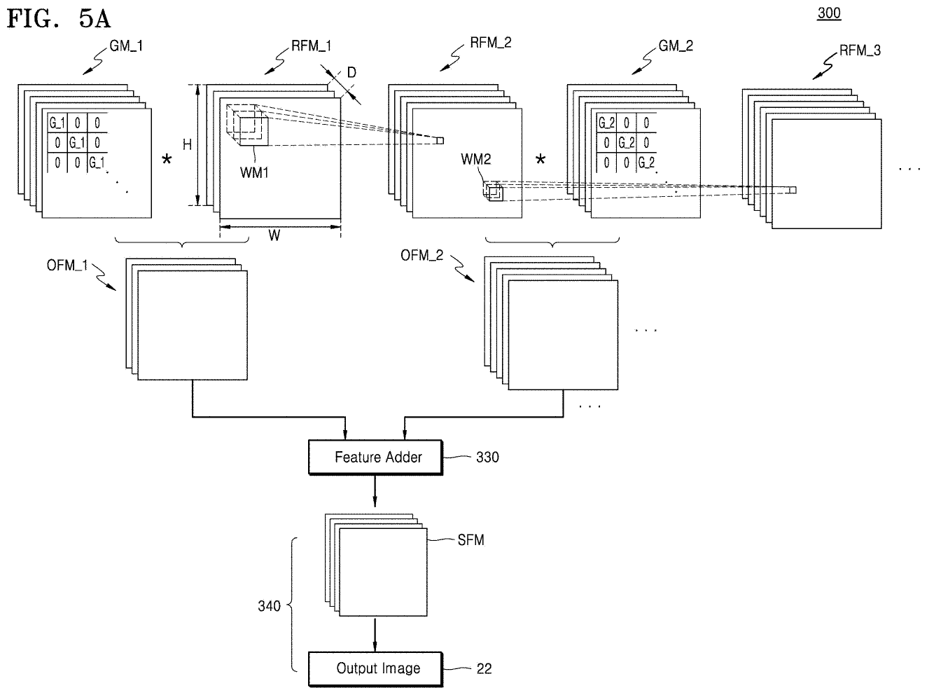

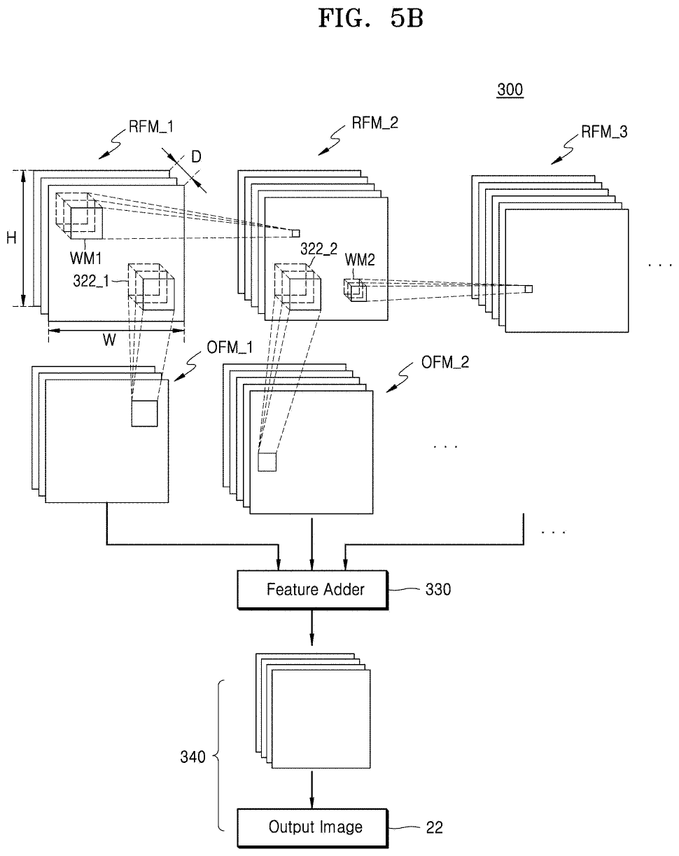

FIG. 5A is a conceptual diagram further illustrating the operation of the neural network device 300 for embodiments using a gain multiplier (e.g., FIG. 3), and FIG. 5B is another conceptual diagram further illustrating the operation of the neural network device 300 using a gain kernel (e.g., FIG. 4).

Referring to FIG. 5A, the neural network device 300 may apply a first gain value G_1 to a first raw feature map RFM_1 and generate a first output feature map OFM_1. For example, the first gain value G_1 may be a value included in a first gain matrix GM_1. The neural network device 300 may also convolute a first weight map WM_1 with the first raw feature map RFM_1 and generate a second raw feature map RFM_2.

According to an embodiment, the gain multiplier 321 may multiply the first raw feature map RFM_1 by the first gain value G_1 and generate the first output feature map OFM_1. The first gain matrix GM_1 may have rows H, columns W, and depths D in equal number to those of the first raw feature map RFM_1. The first gain matrix GM_1 may be implemented as a shape obtained by multiplying a unit matrix by the first gain value G_1 as shown in FIG. 5A. Similar to the first gain matrix GM_1, a second gain matrix GM_2 may also be implemented as a shape obtained by multiplying a unit matrix by the second gain value G_2. That is, an i-th gain matrix may be implemented as a shape obtained by multiplying a unit matrix by an i-th gain value.

The neural network device 300 may increase or reduce a feature value included in a raw feature map RFM according to a gain value included in the gain matrix GM and generate an output feature map OFM. The neural network device 300 may sum a plurality of output feature maps OFM using the feature adder 330 and generate a summed feature map SFM, and reconstruct the summed feature map SFM into an output image 22 using the reconstruction layer 340.

Referring to FIG. 5B, the neural network device 300 may apply a first gain kernel 322_1 to the first raw feature map RFM_1 and generate the first output feature map OFM_1. A row and a column of the first gain kernel 322_1 may be respectively equal to or less than a row and a column of the first raw feature map RFM_1, and a depth of the first gain kernel 322_1 may be equal to a depth of the first raw feature map RFM_1. The neural network device 300 may also convolute the first weight map WM_1 with the first raw feature map RFM_1 and generate the second raw feature map RFM_2.

In the embodiment illustrated in FIG. 5B, the neural network device 300 may convolute the first raw feature map RFM_1 with the first gain kernel 322_1 and generate the first output feature map OFM_1. The neural network device 300 may perform shifting and convolution operations in the manner of traversing the first gain kernel 322_1 using the first raw feature map RFM_1 as a sliding window according to a predetermined stride. Here, the first gain kernel 322_1 may include a plurality of gain kernel values in a matrix form. The gain kernel values included in the first gain kernel 322_1 may be values that are learned with reference to a plurality of pairs of input images and output images. Subsequently, a process of generating the output image 22 using the feature adder 330 and the reconstruction layer 340 may be identical or similar to that described with reference to FIG. 5A and thus, a description thereof will be omitted.

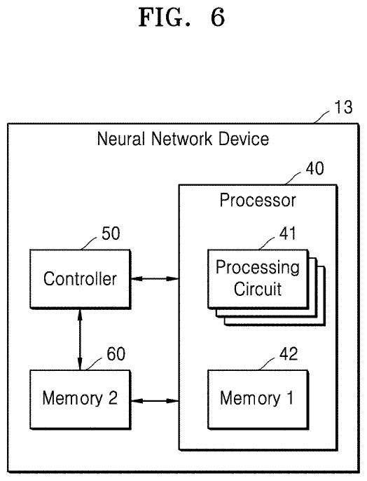

FIG. 6 is a block diagram further illustrating in another example the neural network device 13 of FIG. 1.

Referring to FIG. 6, the neural network device 13 may include a processor 40, a controller 50, and a memory 60. The processor 40 may include a plurality of processing circuits 41 and a memory 42. In addition, the neural network device 13 may further include a direct memory access (DMA) controller to store data in an external memory. Although FIG. 6 illustrates an example in which the neural network device 13 includes one processor 40, the inventive concept is not limited thereto, and the neural network device 13 may include a number of processors 40.

In certain embodiments, the processor 40 may be implemented as hardware circuits. Thus, the neural network device 13 may be implemented as a single semiconductor chip (e.g., a SoC). Alternately, the neural network device 13 may be implemented as a plurality of interconnected semiconductor chips. In the description that follows, the memory 42 included in the processor 40 will be referred to as a first memory 42, and the memory 60 external to the processor 40 will be referred to as a second memory 60.

The controller 50 may be implemented as a CPU or a microprocessor (MP), and may be used to control the overall operation of the neural network device 13. The controller 50 may set and manage neural network operation parameters such that the processor 40 may normally perform operations of layers of a neural network. In addition, the controller 50 may control the plurality of processing circuits 41 to efficiently operate, based on management policies for the neural network device 13, and control inputs/outputs and operation flows of data between components inside/outside the processor 40.

For example, the controller 50 may be loaded in one processing circuit, from among the plurality of processing circuits 41, to compute one raw feature map of the raw feature maps RFM_1 to RFM_N stored in the first memory 42 or the second memory 60 and a gain corresponding to the one raw feature map. The controller 50 may control the processing circuit to generate a first to N-th output feature maps OFM_1 to OFM_N, sum all of the first to N-th output feature maps OFM_1 to OFM_N, generate a summed feature map SFM, and generate an output image 22 corresponding to the summed feature map SFM.

In an embodiment, an algorithm related to the above-described operation of the controller 50 may be implemented as software or firmware, stored in a memory (e.g., the second memory 60), and executed by the above-described CPU or MP.

The plurality of processing circuits 41 may perform allocated operations via the control of the controller 50. The plurality of processing circuits 41 may be implemented to operate in parallel simultaneously. Furthermore, the respective processing circuits 41 may operate independently. For example, each of the processing circuits 41 may be implemented as a core circuit capable of executing instructions. The processing circuit 41 may perform a neural network operation according to an operation method of the neural network system described above with reference to FIGS. 1, 2, 3, 4, 5A and 5B.

The first memory 42 may be an embedded memory of the processor 40 and be SRAM. However, the inventive concept is not limited thereto, and the first memory 42 may be implemented as a simple buffer of the processor 40, a cache memory, or another kind of memory, such as DRAM. The first memory 42 may store data generated due to operations performed by the plurality of processing circuits 41, for example, feature maps or various kinds of pieces of data generated during operation processes. The first memory 42 may be a shared memory of the plurality of processing circuits 41.

The second memory 60 may be implemented as RAM, for example, DRAM or SRAM. However, the inventive concept is not limited thereto, and the second memory 60 may be implemented as a non-volatile memory. The second memory 60 may store various programs and data. The second memory 60 may be accessed by a host processor (e.g., the CPU 11 in FIG. 1) or another external device. In an embodiment, the data storage capacity of the second memory 60 may be greater than that of the first memory 42. In an embodiment, an access latency of the first memory 42 may be less than an access latency of the second memory 60.

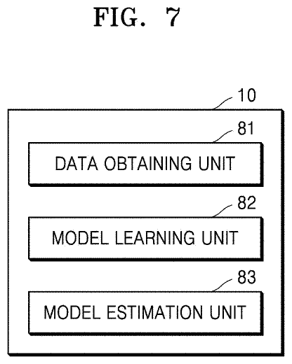

FIG. 7 is a block diagram further illustrating in another example the electronic system 10 of FIG. 1 and a learning operation performed by the neural network device 13 according to an embodiment.

Referring to FIG. 7, the electronic system 10 may include a data obtaining unit 81, a model learning unit 82, and a model estimation unit 83.

The electronic system 10 may learn criteria for determining a noise portion in an input image 21. Also, the electronic system 10 may learn criteria for generating an output image 22 obtained by removing noise from the input image 21. To this end, the electronic system 10 may learn gains respectively corresponding to first to N-th raw feature maps RFM_1 to RFM_N. For example, the electronic system 10 may learn gain matrices or gain kernels and learn values (e.g., gain values or gain kernel values) included in the gain matrices or gain kernels. The electronic system 10 may obtain data to be used for learning (hereinafter, referred to as learning data), apply the learning data to the model learning unit 82, and learn criteria for determining situations.

The data obtaining unit 81 may obtain learning data, for example, pairs of input images 21 and output images 22. For example, the data obtaining unit 81 may receive an input image 21 obtained by capturing an image of a subject in a noise situation (e.g., a foggy weather) and an output image 22 obtained by capturing an image of the subject in a noise-free situation (e.g., a clear weather). That is, the data obtaining unit 81 may obtain pairs of input images 21 and output images 22 obtained by capturing images of similar subjects in different environments.

The data obtaining unit 81 may be implemented as one or more I/O interface(s). For example, pairs of input images 21 and output images 22 may be captured by the sensor module 15. In this case, the data obtaining unit 81 may obtain images from the sensor module 15. Also, the pairs of input images 21 and output images 22 may be images stored in the memory. In this case, the data obtaining unit 81 may obtain images from at least one of the memory 14, the first memory 42, and the second memory 60. Furthermore, the pairs of input images 21 and output images 22 may be images received from an external device and/or a server. In this case, the data obtaining unit 81 may obtain images from various communication modules, such as a transceiver.

The model learning unit 82 may learn criteria for determining noise of the input image 21 and removing the noise, based on the learning data. The model learning unit 82 may learn a gain as an optimum value to remove the noise. For example, the model learning unit 82 may emphasize feature values of a first raw feature map RFM_1 more than feature values of a second raw feature map RFM_2 to remove the noise from the input image 21. The emphasized feature values may appear more prominently than other feature values in a summed feature map SFM and achieve predetermined goals, such as noise reduction. To this end, the model learning unit 82 may learn a plurality of gains differently. As an example, the model learning unit 82 may learn a first gain (e.g., a first gain value G_1 or a first gain kernel 322_1) corresponding to the first raw feature map RFM_1 generated at a first layer 310_1 differently from a second gain (e.g., a second gain value G_2 or a second gain kernel 322_2) corresponding to the second raw feature map RFM_2. As another example, the model learning unit 82 may learn the first gain value G_1 and the second gain value G_2 such that the first gain value G_1 is greater than the second gain value G_2.

The model learning unit 82 may learn the neural network device 300 using various learning algorithms For example, the learning algorithms may include various algorithms, such as error back-propagation and gradient descent. Also, the model learning unit 82 may learn the neural network device 300 via supervised learning using learning data (e.g., a plurality of pairs of input images 21 and output images 22) as input values. Alternately, the model learning unit 82 may learn the neural network device 300 via reinforcement learning using feedback on whether noise has been appropriately removed from the input image 21 as a result of a comparison between the input image 21 and the output image 22.

As described above, the model learning unit 82 may store learned data, for example, at least one of first to N-th gain values G_1 to G_N, first to N-th gain matrices GM_1 to GM_N, and first to N-th gain kernels GK_1 to GK_N in a memory of the electronic system 10. The memory of the electronic system 10 may include at least one of the memory 14, the first memory 42, and the second memory 60. Also, the model learning unit 82 may store the learned neural network device 300 and data and parameters included in the neural network device 300 in the memory.

The model estimation unit 83 may input estimation data to the neural network device 300 and enable the model learning unit 82 to learn again when data output from the estimation data does not satisfy predetermined criteria. In this case, the estimation data may be preset data (e.g., image data) for estimating the neural network device 300.

For example, when a ratio of a noise-remaining region to a frame of the input image 21 exceeds a predetermined critical value, the model estimation unit 83 may estimate that the output data of the learned neural network device 300 to which the estimation data is input does not satisfy the predetermined criteria.

Meanwhile, at least one of the data obtaining unit 81, the model learning unit 82, and the model estimation unit 83 may be manufactured as a type of at least one hardware chip and mounted in the electronic system 10. For instance, at least one of the data obtaining unit 81, the model learning unit 82, and the model estimation unit 83 may be manufactured as a type of a dedicated hardware chip for artificial intelligence (AI) or a dedicated hardware chip (e.g., a neuronal processing unit (NPU)) for a neural network operation or as a portion of an existing general-use processor (e.g., a CPU or an application processor) or a graphics dedicated processor (e.g., a graphics processing unit (GPU)) and mounted in various electronic devices.

Furthermore, the data obtaining unit 81, the model learning unit 82, and the model estimation unit 83 may be mounted in one electronic system 10 or respectively mounted in separate electronic devices. For example, some of the data obtaining unit 81, the model learning unit 82, and the model estimation unit 83 may be included in the electronic system 10, and the remaining ones thereof may be included in a server.

In addition, at least one of the data obtaining unit 81, the model learning unit 82, and the model estimation unit 83 may be implemented as a software module. When at least one of the data obtaining unit 81, the model learning unit 82, and the model estimation unit 83 is implemented as a software module (or a program module including instructions), the software module may be stored in non-transitory computer-readable recording media. In this case, at least one software module may be provided by an OS or a predetermined application. Alternatively, some of at least one software module may be provided by an OS, and the remaining ones thereof may be provided by a predetermined application.

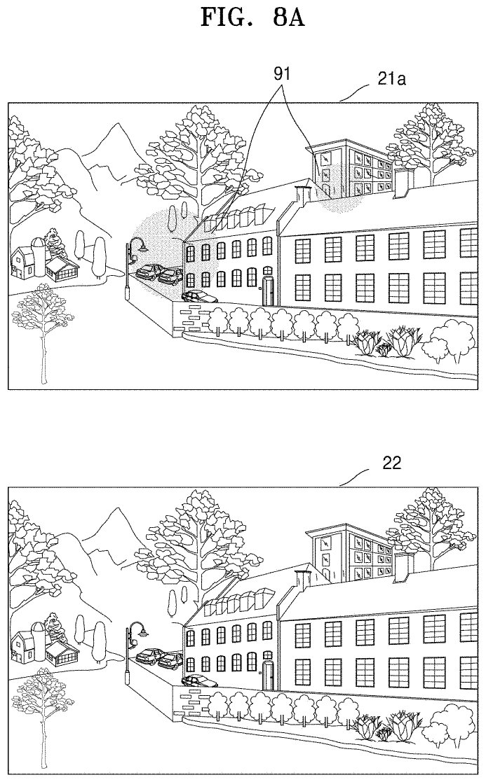

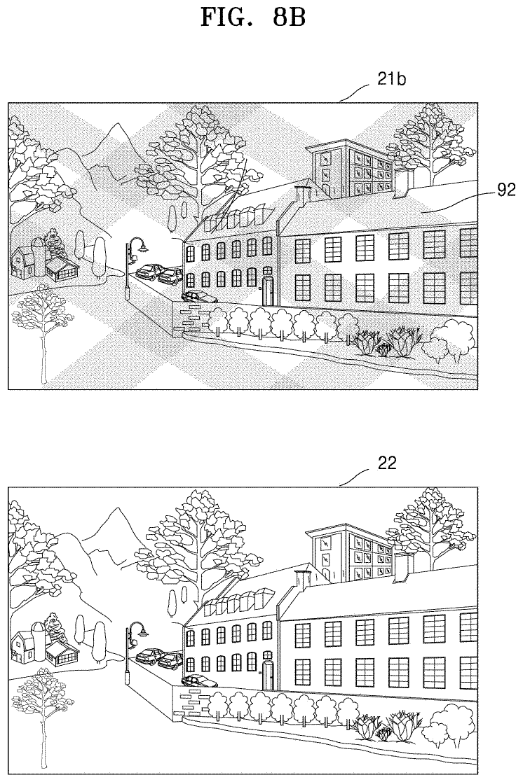

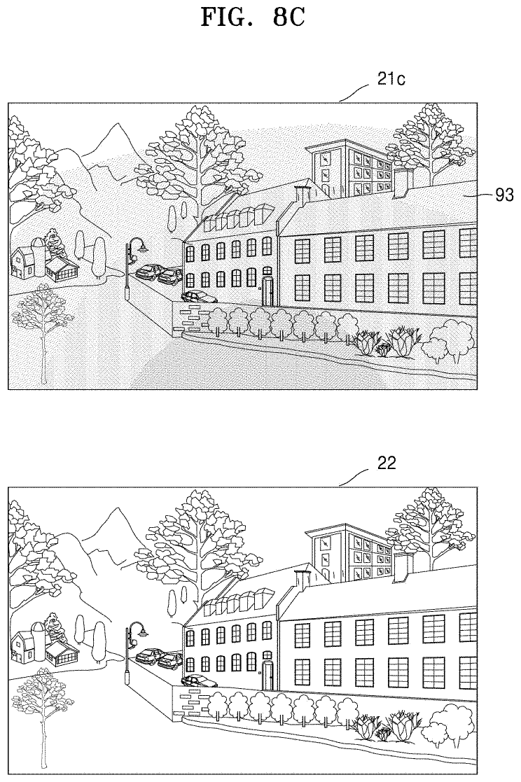

FIGS. 8A, 8B, and 8C are respective diagrams further illustrating possible effects of removing noise from an input image to generate a corresponding output image. Here, various image noise 91, 92, and 93 apparent in first, second and third input images 21a, 21b, and 21c of FIGS. 8A, 8B and 8C, may be at least partial image regions in which variations in various image parameters (e.g., resolution, brightness, Chroma, and an RGB value) occur in image frames.

FIG. 8A shows a situation in which small-sized, unintended object(s) (e.g., small dust or fingerprints on a camera lens) exists in close vicinity to the imaging sensor (e.g., a camera lens). In this case, the noise 91 may occur in an irregular form in selected regions of the first input image 21a.

FIG. 8B shows a situation in which unintended object(s) (e.g., fencing wire) exists between an intended object and an imaging sensor (e.g., camera lens) somewhat closer to the imaging sensor than the object. In this case, the noise 92 having a patterned shape may occur. For example, when a camera lens is disposed closer to fencing wire than an intended object, the focus of the camera lens may be fixed on the object, but the captured image may nonetheless include foreshadowing noise associated with the fencing.

FIG. 8C shows a situation in which a distributed unintended object (e.g., thick smoke or fog) exists around the intended object. This situation tends to blur (or color skew) the captured image as noise 93 broadly included across the image.

These are just selected examples (e.g., 91, 92, 93) of image noise caused by various types of unintended objects proximate an intended object. However, embodiments like those described above including a neural network device 13/300 may be used to effectively remove such noise from an input image 21 and generate an improved output image 22.

According to an embodiment, the neural network device 300 may be learned using pairs of input images and output images, such as a pair of a first input image 21a and an output image 22, a pair of a second input image 21b and an output image 22, and a pair of a third input image 21c and an output image 22. For example, at least one of gain values G_1 to G_N, gain matrices GM_1 to GM_N, and gain kernels GK_1 to GK_N may be learned.

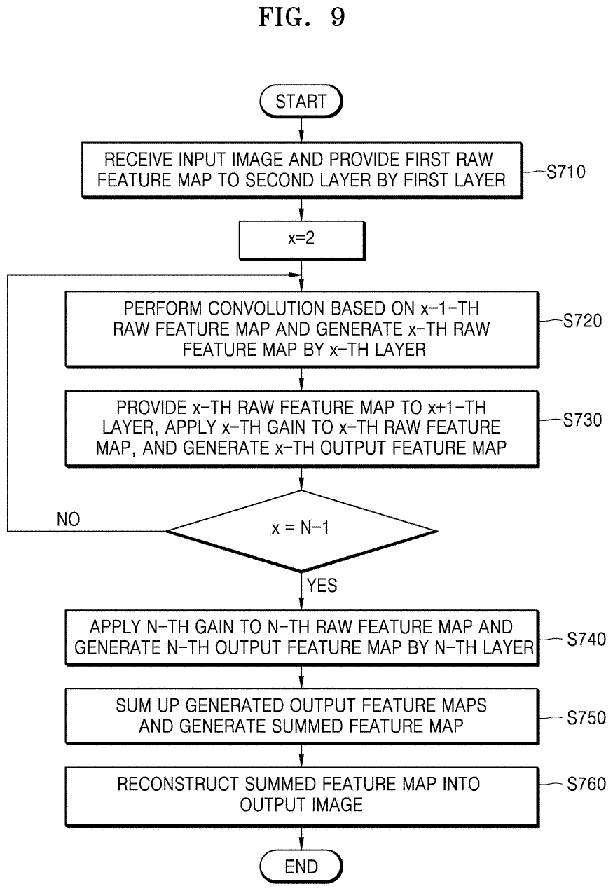

FIG. 9 is a flowchart summarizing in one embodiment a method of operating an electronic system like the ones described above with respect to FIGS. 1, 3, 4, 6 and 7. Hereafter, the exemplary method of operation will be described in relation to the embodiment of FIG. 1.

In operation S710, a neural network device 13 may receive an input image using a first layer 310_1 and provide a first raw feature map RFM_1 to a second layer 310_2.

In operation S720, the neural network device 13 may convolute an x−1-th raw feature map using an x-the layer and generate an x-th raw feature map. Here, an initial value of x may be 2. In other words, the neural network device 13 may convolute the first raw feature map RFM_1 with a first weight map using the second layer 310_2 and generate a second raw feature map RFM_2.

In operation S730, the neural network device 13 may provide an x-th raw feature map to an x+1-th layer, apply an x-th gain to the x-th raw feature map, and store an x-th output feature map. For example, the neural network device 13 may provide the second raw feature map RFM_2 to a third layer 310_3, apply a second gain corresponding to the second raw feature map RFM_2 to the second raw feature map RFM_2, and generate a second output feature map OFM_2.

After operations S720 and S730 are performed, the neural network device 13 may repeat operations S720 and S730 to generate subsequent output feature maps, such as a third output feature map and a fourth output feature map. That is, the neural network device 13 may repeatedly perform operations S720 and S730 until an N-th output feature map OFM_N is generated.

In operation S740, the neural network device 13 may apply an N-th gain to an N-th raw feature map RFM_N using an N-th layer 310_N and generate an N-th output feature map OFM_N. In this case, the first to N-th layers 310_1 to 310_N may be cascade-connected. Since the cascade-connection of the first to N-th layers 310_1 to 310_N is described in detail above with reference to FIG. 3, a description thereof is omitted.

According to an embodiment, the neural network device 13 may repeatedly perform operations S720 and S730 by increasing x in increments of 1 from 2 to N−1 (N is the number of a plurality of layers), and perform operation S740. Thus, the neural network device 13 may generate first to N-th output feature maps OFM_1 to OFM_N.

According to another embodiment, the neural network device 13 may perform operations S720 and S730 only when x is some values of 2 to N−1 and may not perform operation S740. When operation S740 is not performed, the neural network device 13 may perform operation S750 after performing operation S730. For example, the neural network device 13 may generate only some output feature maps from among the first to N-th output feature maps OFM_1 to OFM_N, such as a first output feature map, a fourth output feature map, and a sixth output feature map.

In operation S750, the neural network device 13 may sum the generated output feature maps and generate a summed feature map SFM. For example, the summed feature map SFM may be a feature map in which characteristics of respective layers are differentially reflected by gains.

In operation S760, the neural network device 13 may reconstruct the summed feature map SFM into an output image 22. As an example, the neural network device 13 may reconstruct the summed feature map SFM into the output image 22 using a reconstruction layer 340. The reconstruction layer 340 may be a convolution layer and be implemented as various layers that may reconstruct a feature map into an image data form.

Typical example embodiments of the inventive concept are disclosed in the above description and the accompanying drawings. Although specific terms are employed, they are used in a generic and descriptive sense only and not for purposes of limitation. It will be understood by those of ordinary skill in the art that various changes in form and details may be made to the disclosed embodiments without departing from the spirit and scope of the inventive concept as defined by the following claims.

What is claimed is:

1. An electronic system that receives input data and generates output data, the electronic system comprising:
a neural network device including a plurality of layers, the neural network device further including a processor,
wherein the processor is configured to generate a plurality of raw feature maps at each of the plurality of layers, apply a gain corresponding to each of the plurality of raw feature maps to generate a plurality of output feature maps, and generate the output data as a summation of the plurality of output feature maps using an image reconstruction layer; and
a memory that stores a plurality of gains, respectively corresponding to each of the plurality of layers.

2. The electronic system of claim 1, wherein the plurality of layers comprises N layers including first to N-th layers sequentially cascade-connected, wherein an i-th layer among the N layer provides an i-th raw feature map to an i+1-th layer among the N layers, and
an i-th gain corresponding to an i-th layer among the N layer is applied to the i-th raw feature map,
where ‘i’ is an integer varying from 1 to N.

3. The electronic system of claim 1, wherein each one of the plurality of layers and the image reconstruction layer is a convolution layer.

4. The electronic system of claim 1, wherein the processor provides a summed feature map obtained by summing the plurality of output feature maps to the image reconstruction layer, and the image reconstruction layer provides the output data.

5. The electronic system of claim 1, wherein the input data is image data captured by an image sensor and includes an object and noise, and the output data is an output image obtained by removing the noise from the input image.

6. The electronic system of claim 5, wherein the input image and the output image include the object, and the noise degrades resolution of the input image.

7. The electronic system of claim 1, wherein the processor is further configured to learn a gain among the plurality of gains based on a pair of the input image and the output image and store the learned gain in the memory.

8. The electronic system of claim 7, wherein the learned gain is learned to reinforce a feature value of a feature map output by a layer corresponding to the gain.

9. The electronic system of claim 1, wherein the gain is implemented as a gain kernel, and
the plurality of output feature maps are generated based on the raw feature map and the gain kernel corresponding to the raw feature map.

10. The electronic system of claim 9, wherein the gain kernel is implemented in a matrix form comprising a plurality of gain kernel values, and the plurality of output feature maps are generated by convoluting the raw feature map with the gain kernel.

11. A non-transitory computer-readable recording medium having recorded a program for generating an output image from an input image using a neural network device, the program comprising:
receiving the input image;
generating a plurality of raw feature maps from some or all of cascade-connected convolution layers based on the input image;
applying a gain corresponding to each of the plurality of generated raw feature maps and generating a plurality of output feature maps; and
generating the output image based on the plurality of output feature maps,
wherein the gain is learned by a learning algorithm and updated when the program is performed.

12. The non-transitory computer-readable recording medium of claim 11, wherein the program further comprises:
convoluting an x−1-th raw feature map received from an x−1-th convolution layer with an x-th weight map;
generating an x-th raw feature map; and
providing the x-th raw feature map to an x+1 convolution layer, wherein the convoluting, generating, and providing are performed by an x-th convolution layer, and x is an integer greater than 1.

13. The non-transitory computer-readable recording medium of claim 11, wherein the cascade-connected convolution layers comprise N convolution layers comprising first to N-th convolution layers, wherein N is an integer greater than 1,
the generating of the plurality of raw feature maps comprises generating the plurality of raw feature maps from all of the cascade-connected convolution layers, and
feature values of first to N−1-th output feature maps, except for an N-th output feature map generated based on the N-th convolution layer, are 0.

14. The non-transitory computer-readable recording medium of claim 11, wherein the input image comprises an object and noise that occupies at least a partial region of the input image, and
the output image is obtained by removing the noise from the input image.

15. The non-transitory computer-readable recording medium of claim 11, wherein the gain is learned and stored based on a pair of the input image and the output image.

16. The non-transitory computer-readable recording medium of claim 11, wherein the generating of the output image comprises summing the plurality of output feature maps to generate a summed feature map and reconstructing the summed feature map to generate the output image.

17. The non-transitory computer-readable recording medium of claim 11, wherein the output image is generated by a reconstruction layer,
the reconstruction layer comprises a convolution layer configured to receive a feature map as an input value and output an image.

18. The non-transitory computer-readable recording medium of claim 11, wherein the gain comprises a gain matrix obtained by multiplying a unit matrix by a gain value.

19. The non-transitory computer-readable recording medium of claim 11, wherein the gain comprises a gain kernel and is smaller than a matrix size of a raw feature map that is convoluted with the gain kernel.

20. A computing device configured to perform an operation using a neural network including a plurality of layers, the computing device comprising:
a sensor module configured to generate an input image;
a memory in which a gain corresponding to each of the plurality of layers is stored; and
a processor configured to receive the input image to generate a plurality of raw feature maps at each of the plurality of layers, apply a gain corresponding to each of the plurality of raw feature maps to generate a plurality of output feature maps, and generate an output image as a result of summation of the plurality of output feature maps due to an image reconstruction layer.
